(19) United States
(12) Patent Application Publication
(10) Pub. No.: US 2008/0138585 A1
(43) Pub. Date: Jun. 12, 2008

(54) Composite Layered Plate for Fire Doors

(75) Inventor: Harry Maier, Dudenhofen (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/577,048

(22) PCT Filed: Oct. 8, 2005
(86) PCT No.: PCT/EP05/10849

§ 371 Date: Apr. 11, 2007

(30) Foreign Application Priority Data
Oct. 11, 2004 (DE) 10 2004 049 632.3

(51) Int. Cl. B32B 3/00; B29C 65/00; B32B 27/38; B32B 9/04

(52) U.S. Cl. 428/172; 156/83; 428/414; 428/446

(57) ABSTRACT

A composite layered sheet, comprising at least
a) a fire-protection layer A with an intumescent composition based on an alkali metal silicate and, applied on the two sides,
b) protective layers B and B′, and
c) a substrate layer C composed of wood, fiberboard, gypsum plasterboard, or calcium silicate board, paper, metal, plastic, or of another fire-protection layer, and production process, and use as core material for a fire-protection door.

The invention relates to composite layered sheets, comprising at least
a) a fire-protection layer A with an intumescent composition based on an alkali metal silicate and, applied on the two sides,
b) protective layers B and B′, and
c) a substrate layer C composed of inorganic or organic construction materials, paper, metal, plastic, or of another fire-protection layer, and a process for their production.

Thermally insulating fire-protection layers based on alkali metal silicates which expand on exposure to high temperatures to give a stable foam layer are known by way of example from DE-B-1169832. However, because alkali metal silicates are sensitive to exposure to moisture and carbon dioxide, they have to be protected from exposure to these via a protective layer. DE-A-1621799 describes fire-protection sheets composed of alkali metal silicates with a protective layer composed of epoxy resin.

One of the principle application sectors for fire-protection materials is fire-protection doors composed of wood, in which the flame-retardant layer has to be applied to the wood or to a particle fiberboard by nailing or adhesive-bonding. In order to achieve sufficient adhesion, expensive specialized adhesives have to be used, or filler grains have to be embedded into the surface of the epoxy resin layer (EP-B 0743292).

It was therefore an object of the invention to find composite layered sheets for fire-protection doors which can be used in woodworking factories without complicated adhesive bonding by specialized adhesives. A further intention was to find a simple and inexpensive process for production of the composite layered sheets.

The composite layered sheet described at the outset has accordingly been found.

The fire-protection layer A is preferably formed from an intumescent composition based on a sodium silicate. To this end, a commercially available water glass solution with water content of about 65% by weight is used and is mixed with water glass powder with water content of about 18% by weight. Mixing times for the mixture can be adjusted precisely by way of the amount of water glass powder. If appropriate, inorganic fillers, such as metal hydroxides or metal sulfate hydrates can be added in amounts of from 0 to 50% by weight to the mixture, as can up to 10% by weight of organic materials. The fire-protection layer A generally comprises glass fibers in amounts of from 2 to 20% by weight, for reinforcement.

The thickness of the fire-protection layer A is generally in the range from 1 to 5 mm, preferably in the range from 1.5 to 3 mm. Its preparation is described by way of example in DE-A-1621799.

The protective layers B and B′ are preferably composed of an epoxy resin or polyurethane resin, and their thickness is in the range from 10 to 500 μm, preferably in the range from 20 to 100 μm.

Substrate layers C which may be used are inorganic or organic construction materials, such as wood, medium- or high-density fiberboard, gypsum plasterboard or calcium silicate board, paper, metal, or plastic.

However, it is also possible to use another fire-protection layer as substrate layer C. Like the fire-protection layer A, the other fire-protection layer may comprise an intumescent composition based on an alkali metal silicate, or else an intumescent composition based on an expandable graphite, for example as described in EP-A 0694574. This method can produce fire-protection layers with relatively high thickness or with balanced fire performance.

The thickness of the substrate layer C may vary within a wide range and is substantially dependent on the construction material used and the intended application. The thickness of the substrate layer C is usually in the range from 0.1 to 500 mm, preferably in the range from 1 to 100 mm.

The inventive composite layered sheet therefore has the layer sequence B′-A-B-C. However, it may also comprise two or more substrate layers C. In this case, both the protective layer B and the protective layer B′ act as tie layers between the fire-protection layer A and the substrate layers C. Preferred layer sequences are C-B′-A-B-C or C-B′-A-B-C-B-A-B′-C.

The inventive composite layered sheets can be produced by applying an epoxy/hardener mixture or a polyurethane adhesive to the fire-protection layer A, and applying the substrate layer C prior to complete curing of the protective layer B. The curing may be carried out in a press, for example in a veneer press, the pressure in the press during curing being in the range from 0.1 to 10 bar, preferably in the range from 2 to 5 bar. The other protective layer B′ may be applied to the opposite side of the fire-protection layer A, and cured in advance or after production of the composite and reversal of the material.

This process can be repeated as desired in order to form other layers. It is preferable that the fire-protection layers A are coated with an epoxy/hardener mixture or with a polyurethane adhesive and stacked with two or more substrate layers C in the desired layer sequence. Curing is preferably then carried out via pressing of the entire composite in the press. Because the fire-protection layer A is more flexible while still uncoated, this achieves better pressing and smaller variations in thickness. The temperature during the curing process is substantially dependent on the nature and constitution of the epoxy/hardener mixture or of the polyurethane adhesive, and is generally in the range from 20 to 100° C. At higher temperatures, the press time selected has to be appropriately shorter in order to inhibit foaming of the fire-protection layers A.

The inventive composite-layered sheets can readily be processed in non-automated factories via conventional processing machinery, via sawing, cutting, or stamping. Composite layered sheets with a substrate layer C composed of medium- or high-density fiberboard are particularly suitable as core material for fire-protection doors.

### EXAMPLES

### Example 1

Using a method based on example 1 of DE-A-1621799, the epoxy/hardener mixture described in that publication was applied on one side, using a weight per unit area of 90 g/m², to a sheet of thickness 1.2 mm, composed of glass-fiber-reinforced sodium silicate. A medium-density fiberboard of thickness 1 mm was then applied and cured in a veneer press for 10 minutes at 80° C., the pressure in the press being 4 kg/cm².

### Example 2

Using a method similar to that of example 1, an epoxy/hardener mixture was applied, using a weight per unit area of 90 g/m², to both sides of a sheet of thickness 1.2 mm composed of glass-fiber-reinforced sodium silicate, and a medium-density fiberboard of thickness 1 mm was applied to each side. The resultant composite was cured as in example 1 in a veneer press to give a composite of layer sequence C-B′-A-B-C.

1.-9. (canceled)

10. A process for production of a composite layered sheet, which comprises applying an epoxy resin/hardener mixture or a polyurethane adhesive to a fire-protection layer A with an intumescent composition based on an alkali metal silicate, to form a protective layer B, and, prior to full curing of the protective layer B, applying a substrate layer C composed of wood, fiberboard, paper, metal, or plastic, and carrying out the curing in a press.

11. The process according to claim 10, wherein the pressure in the press during curing is in the range from 0.1 to 10 bar.

12. The process according to claim 10, wherein, prior to or after application of the protective layer B and of the substrate layer C, another protective layer B′ is applied to the fire-protection layer A and cured.

13. A composite layered sheet, comprising at least
a) a fire-protection layer A with an intumescent composition based on an alkali metal silicate and, applied on the two sides,
b) protective layers B and B′, which are composed of an epoxy resin or polyurethane resin and act as tie layers between the fire-protection layer A and the substrate layer C, and
c) a substrate layer C composed of inorganic or organic construction materials, paper, metal, plastic, and
the composite layered sheet having the layer sequence B′-A-B-C.

14. The composite layered sheet according to claim 13, wherein the fire-protection layer A is composed of a fiber-reinforced, hydrous sodium silicate.

15. The composite layered sheet according to claim 13, wherein the substrate layer C comprises, as inorganic or organic construction materials, wood, medium- or high-density fiberboard, gypsum plaster, or calcium silicate.

16. The composite layered sheet according to claim 14, wherein the substrate layer C comprises, as inorganic or organic construction materials, wood, medium- or high-density fiberboard, gypsum plaster, or calcium silicate.

17. The composite layered sheet according to claim 13, wherein the thickness of the fire-protection layer A is from 1 to 5 mm, the thickness of each of the protective layers B and B′ is in the range from 10 to 500 μm, and the thickness of the substrate layer C is in the range from 0.1 to 100 mm.

18. The composite layered sheet according to claim 16, wherein the thickness of the fire-protection layer A is from 1 to 5 mm, the thickness of each of the protective layers B and B′ is in the range from 10 to 500 μm, and the thickness of the substrate layer C is in the range from 0.1 to 100 mm.

19. The composite layered sheet according to claim 13, which is composed of the layer sequence C-B′-A-B-C.

20. The composite layered sheet according to claim 18, which is composed of the layer sequence C-B′-A-B-C.
a) The composite layered sheet according to claim 13, wherein the composite layered sheet having the layer sequence B′-A-B-C is prepared by the process according to claim 10.

21. A fire-protection door, comprising a composite layered sheet according to claim 13.

22. A fire-protection door, comprising a composite layered sheet according to claim 19.
